(19) United States
(12) Patent Application Publication
(10) Pub. No.: US 2008/0168212 A1
(43) Pub. Date: Jul. 10, 2008

(54) Techniques for audio and image capture

(75) Inventors: August de los Reyes, Bellevue, WA (US); Paul E. Henderson, Redmond, WA (US); Ruston Panabaker, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/650,905

(22) Filed: Jan. 8, 2007

(51) Int. Cl. G06F 12/06

(52) U.S. Cl. 711/103; 711/E12.008

(57) ABSTRACT

Techniques are provided for capturing audio and image information. A capture device may be used to capture audio and/or image information. The device includes at least one of an audio and a image capturing component for capturing information, a flash memory, and a button for use in connection with controlling capture of the information. Capturing of the information is performed while holding the button in a depressed position. Capturing of the information is stopped when the button is released.

### BACKGROUND

Existing search engines may be accessible from a computer. The search engine may be used to perform queries of content found on the Internet as well as queries of other data sources such as a database. The search engine may be used to perform such queries while the computer has connectivity to a network or other data source to be searched. The search engine may include a user interface to facilitate obtaining search queries in an interactive manner. One drawback of the foregoing is that a user's computer or network used to connect the computer to the search engine or data source to be searched may be having problems. As such, when the user wants to perform a query, the computer may not have connectivity to the search engine, data source to be searched, and the like. In such instances, the user may have to access the search engine or data source at a later point in time when existing problems have been resolved in order to enter the search query, perform the search, and obtain any search results.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques are provided for capturing audio and/or image information using a capture device. The capture device includes components for performing the audio and/or image capturing, a flash memory or other form of non-volatile memory, and a button used to control the information capture operation. The capture device may be used to facilitate capturing of information when connected, as well as when not connected, to another device or application that may utilize the captured information. The captured data may be automatically downloaded from the capture device.

### DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment illustrating an environment that may be utilized in connection with the techniques described herein;

FIG. 2 is an example of components that may be included in an embodiment of a device for use in connection with performing the techniques described herein;

FIG. 3 is an example of components that may be included in an embodiment of a server;

FIG. 4 is an example of components that may be included in an embodiment of a device and associated capture device for use in connection with performing the techniques described herein;

FIG. 5 is an exemplary embodiment of a block diagram of components that may be included in a capture device that performs audio capture;

FIG. 6 is an exemplary embodiment of a block diagram of components that may be included in a capture device that performs image capture;

FIG. 7 is an exemplary embodiment of a block diagram of components that may be included in a capture device that performs audio and image capture;

FIG. 8 is another exemplary embodiment of a block diagram of components that may be included in a capture device that performs audio capture;

FIG. 9 is an exemplary embodiment illustrating a capture device integrated in another device or component; and

FIG. 10 is a flowchart of processing steps that may be performed in an embodiment in connection with the techniques herein.

### DETAILED DESCRIPTION

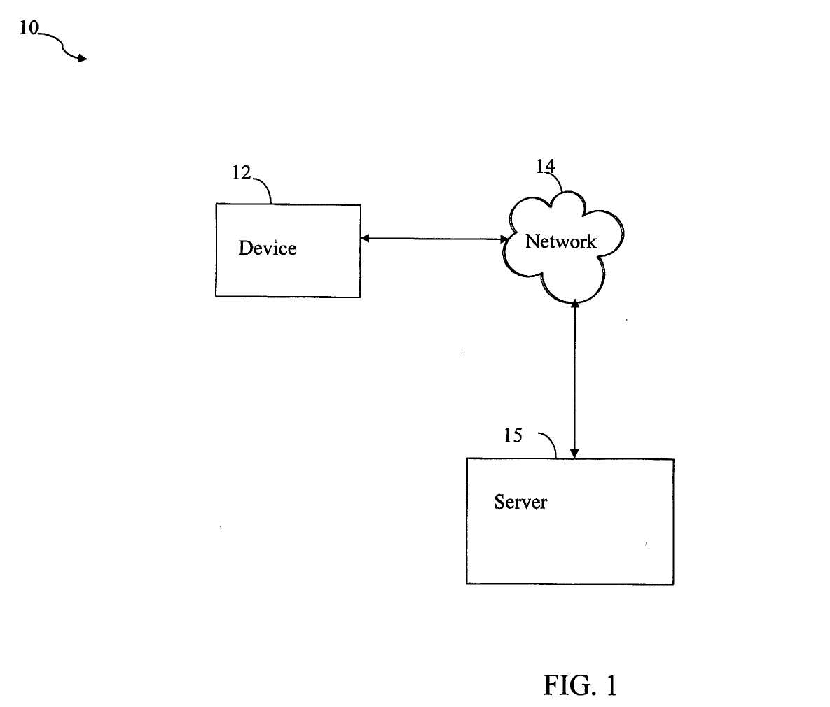

Referring now to FIG. 1, illustrated is an example of a suitable computing environment in which embodiments utilizing the techniques described herein may be implemented. The computing environment illustrated in FIG. 1 is only one example of a suitable computing environment and is not intended to suggest any limitation as to the scope of use or functionality of the techniques described herein in connection with a capture device that may be used in connection with audio and/or image capture. Those skilled in the art will appreciate that the techniques described herein may be suitable for use with other general purpose and specialized purpose computing environments and configurations. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The techniques set forth herein may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments.

Included in FIG. 1 are a device 12, a network 14, and a server 15. The device 12 may be, for example, a computer having a display or output device such as a personal or desk top computer. The device 12 included in FIG. 1 is exemplary for purposes of illustrating the techniques described herein in connection with an audio and image capture device that may be used with a computer or other device 12. In one embodiment, any device that has connectivity to the server 15 and having the functionality described herein may be included in an embodiment. The device 12 may include a processor used to execute code included in one or more program modules. Described in more detail elsewhere herein are program modules that may be executed by the device 12 in connection with the techniques described herein. The device 12 may operate in a networked environment and communicate with the communications server 15 and other computers not shown in FIG. 1. As described herein, the device 12 may be a personal computer. In other embodiments, the functionality of device 12, or the device 12 itself, may be included in another component in accordance with a particular environment in which the device 12 is utilized.

The server 15 may communicate with device 12 when connected to the network 14. The server 15 may include one or more applications and associated data for use in connection with communications to device 12. For example, the server 15 may host a server portion of an electronic calendar and messaging program, and other applications. The device 12 may include a client-side application for use with the electronic calendar and messaging program which, when connected to the server 15, communications with the respective server-side application and utilizes data stored at the server 15. The device 12 may also include, for example, a search engine used to perform queries of Internet-based content.

It will be appreciated by those skilled in the art that although the device 12 is shown in the example as communicating in a networked environment, the device 12 may communicate with other components utilizing different communication mediums. For example, the device 12 may communicate with one or more components utilizing a network connection, and/or other type of link known in the art including, but not limited to, the Internet, an intranet, or other wireless and/or hardwired connection(s).

It should also be noted that although the device 12 is illustrated as having connectivity to a server 15, the techniques described herein may be used in connection with a device 12 operating standalone without external connection to a server and/or network

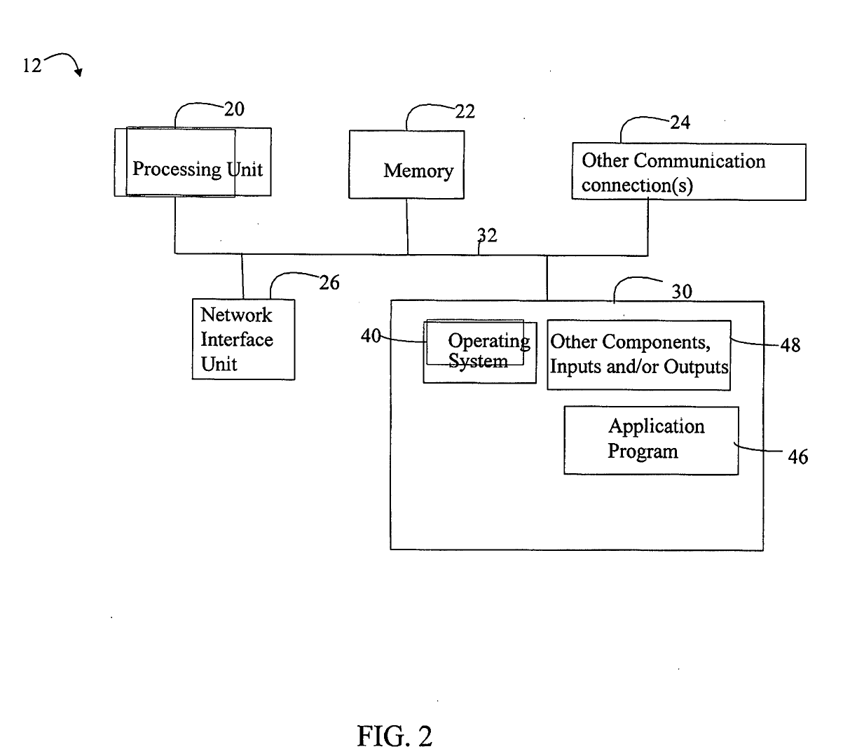

Referring now to FIG. 2, shown is an example of components that may be included in the device 12 as may be used in connection with performing the various embodiments of the techniques described herein. The device 12 may include one or more processing units 20, memory 22, a network interface unit 26, storage 30, one or more other communication connections 24, and a system bus 32 used to facilitate communications between the components of the device 12.

Depending on the configuration and type of user device 12, memory 22 may be volatile (such as RAM), non-volatile (such as ROM, flash memory, etc.) or some combination of the two. Additionally, the device 12 may also have additional features/functionality. For example, the device 12 may also include additional storage (removable and/or non-removable) including, but not limited to, USB devices, magnetic or optical disks, or tape. Such additional storage is illustrated in FIG. 2 by storage 30. The storage 30 of FIG. 2 may include one or more removable and non-removable storage devices having associated computer-readable media that may be utilized by the device 12. The storage 30 in one embodiment may be a mass-storage device with associated computer-readable media providing non-volatile storage for the device 12. Although the description of computer-readable media as illustrated in this example may refer to a mass storage device, such as a hard disk or CD-ROM drive, it will be appreciated by those skilled in the art that the computer-readable media can be any available media that can be accessed by the device 12.

By way of example, and not limitation, computer readable media may comprise computer storage media and communication media. Memory 22, as well as storage 30, are examples of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by device 12. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The device 12 may also contain communications connection(s) 24 that allow the computer to communicate with other devices and components such as, by way of example, input devices and output devices. Input devices may include, for example, a keyboard, mouse, pen, voice input device, touch input device, etc. Output device(s) may include, for example, a display, speakers, printer, and the like. These and other devices are well known in the art and need not be discussed at length here. The one or more communications connection(s) 24 are an example of communication media. In one embodiment, the device 12 may be connected to a touchscreen display as a user interface. As known in the art, a user selection may be made using a touchscreen device by touching a location on the screen or display surface. The foregoing may be used, for example, as an alternative to obtaining user input with another input device such as a mouse, keyboard, and the like.

In one embodiment, the device 12 may operate in a networked environment as illustrated in FIG. 1 using logical connections to remote computers through a network. The device 12 may connect to the network 14 of FIG. 1 through a network interface unit 26 connected to bus 32. The network interface unit 26 may also be utilized in connection with other types of networks and/or remote systems and components.

One or more program modules and/or data files may be included in storage 30. During operation of the device 12, one or more of these elements included in the storage 30 may also reside in a portion of memory 22, such as, for example, RAM for controlling the operation of the user computer 12. The example of FIG. 2 illustrates various components including an operating system 40, one or more application programs 46, and other components, inputs, and/or outputs 48. In one embodiment, the application program 46 may be a web browser, a client-side application, or other application used when operating the device 12 standalone and/or with external connectivity.

As will be described herein, the device 12 may include one or more ports for use in connection with external devices. In one embodiment, the device 12 may be a computer and include one or more ports, such as USB ports, for use with other devices, such as USB devices. One such USB device that may be used in connection with the computer or other device 12 may be a USB device may be characterized as an audio and/or image capture device that can perform audio and/or image capture. The USB device may also be used as a storage device.

The operating system 40 may be any one of a variety of commercially available or proprietary operating systems. The operating system 40, for example, may be loaded into memory in connection with controlling operation of the user computer. One or more application programs 46 may execute in the device 12 in connection with performing user tasks and operations.

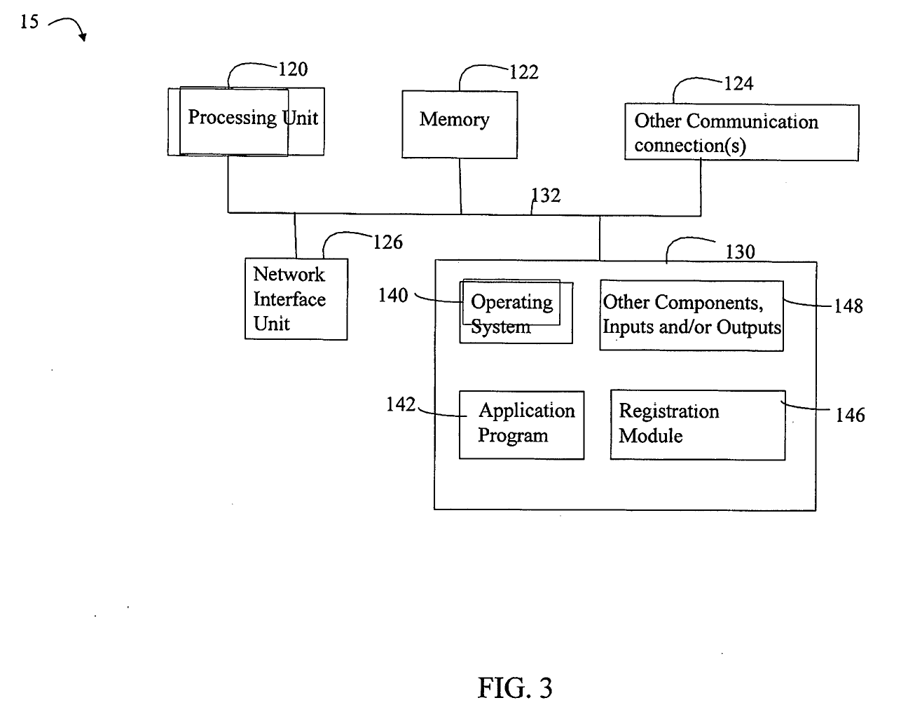

Referring now to FIG. 3, shown is an example of components that may be included in the server 15 and used in connection with performing the various embodiments of the techniques described herein. As illustrated in FIG. 3, an embodiment of the server 15 may include components similar to those described in connection with FIG. 2. Additionally, the server 15 may include a registration module 146 for registering one or more users of the server. In one embodiment, a user of the device 12 may be registered. In connection with techniques herein, each user may have an electronic email account, a calendar, and the like. Information for each of the foregoing may be maintained at the server 15. The registration module 146 may be used in connection with registration of a user. As part of the registration process, the user may be assigned a user identifier, an associated email account, and the like.

The server 15 may also include one or more applications 142, such as client-side applications, which may be accessed and executed when device 12 is connected to the server 15. The application 142 may perform, for example, a service, for a user of a connected device 12.

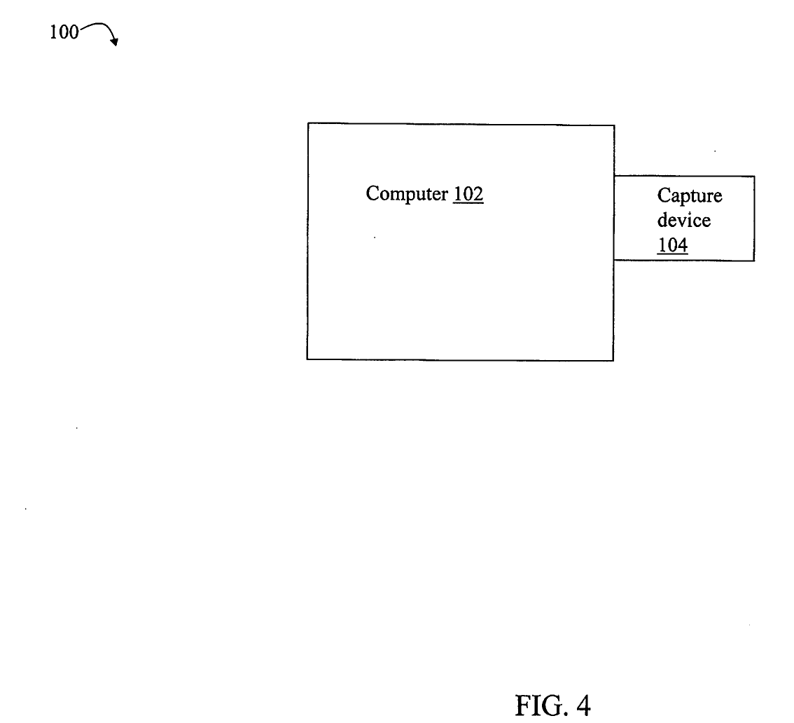

Referring now to FIG. 4, shown is an example illustrating a computer 102 and a capture device 104. A capture device, as mentioned above, is illustrated in FIG. 4 as element 104 and may be used in connection with the computer 102 to perform audio and/or image capture.

As described in more detail elsewhere herein in one embodiment, the capture device 104 may be a USB device. The capture device 104 may include functionality for performing audio and/or image capture. The capture device 104 may perform the audio and/or image capture in a standalone mode when the device 104 is not connected to another device, such as the computer 102. The capture device 104 may also perform the audio and/or image capture when the capture device 104 connected to another device, such as the computer 102. The captured audio and/or video information may be stored on the capture device 104. The captured information may be downloaded to the computer 102 when the capture device 104 is connected to the computer 102, such as when the capture device 104 is inserted into a communications port of the computer 102. As will be described in more detail herein, such downloading of the captured information may occur using an automated technique as well as using non-automated techniques.

What will now be described are various embodiments of the capture device 104. It should be noted that although the exemplary capture devices described herein are USB devices, it will be appreciated by those skilled in the art that the functionality described herein may be used in connection with other types of devices and is not limited for use with USB devices.

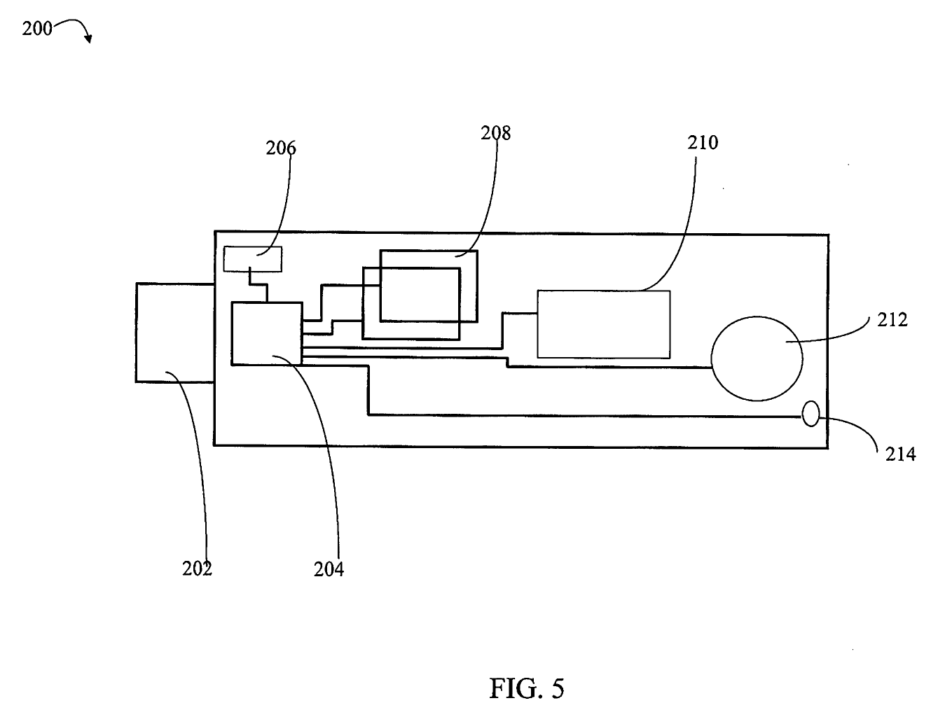

Referring now to FIG. 5, shown is an example of an embodiment of a capture device. The example 200 illustrates a block diagram of a capture device including functionality for audio capture. The example 200 includes a USB connector 202, a device controller 204, a battery-backed clock, one or more flash memory components 208, a battery 210, a button 212, and a microphone 214. The USB connector 202 may be used in connection with connected the capture device into a port of another device, such as the computer 102 of FIG. 4, capable of receiving the USB connector 202. The battery 210 may be a replaceable or rechargeable battery used to supply power to the components of the capture device 200. The flash memory components 208 may include one or more flash memory chips. As known in the art, flash memory is one form of non-volatile memory that can be electrically erased and reprogrammed for use with the techniques herein.

The microphone 214 may be used in connection with recording audio communications, such as voice or other sound recordings, which are stored on the flash memory components 208.

The device controller 204 may be used in connection with controlling components on the capture device 200. The device controller 204 may also include other circuitry for use in connection with the components, such as the microphone 214. In one embodiment, audio information may be recorded using the microphone 214. The microphone 214 may convert the sound information into electrical audio signals which are sent to the device controller 204. The controller 204 may also include components therein for performing audio processing of the received signals from the microphone 214. The controller 204 may facilitate converting the received audio signals to a digital form which is then represented and stored in an audio file in a location on the flash memory 208. The audio file may be stored, for example, in a particular location such as a default directory, folder, file, and the like. The controller 204 may also determine and store additional information about the captured audio information. The additional information may include metadata about the captured audio information. For example, in one embodiment, date and/or time information as to when the audio information is captured may be stored with the captured audio information.

The button 212 may be used to control operation of microphone 214 and facilitate recording of the audio information. In one embodiment, the button 212 may be depressed and held down in the depressed state and then released at a later point in time. Recording or capturing of the audio information may be performed while the button 212 is depressed. Once the button 212 is released, the audio recording may terminate. In a variation of the foregoing, the button 212 may also be depressed and released a first time causing audio recording to begin. Audio recording may continue until the next time the button 212 is depressed and released. In one embodiment, the audio information captured between a single instance of starting and stopping an audio recording may be included in a single audio file.

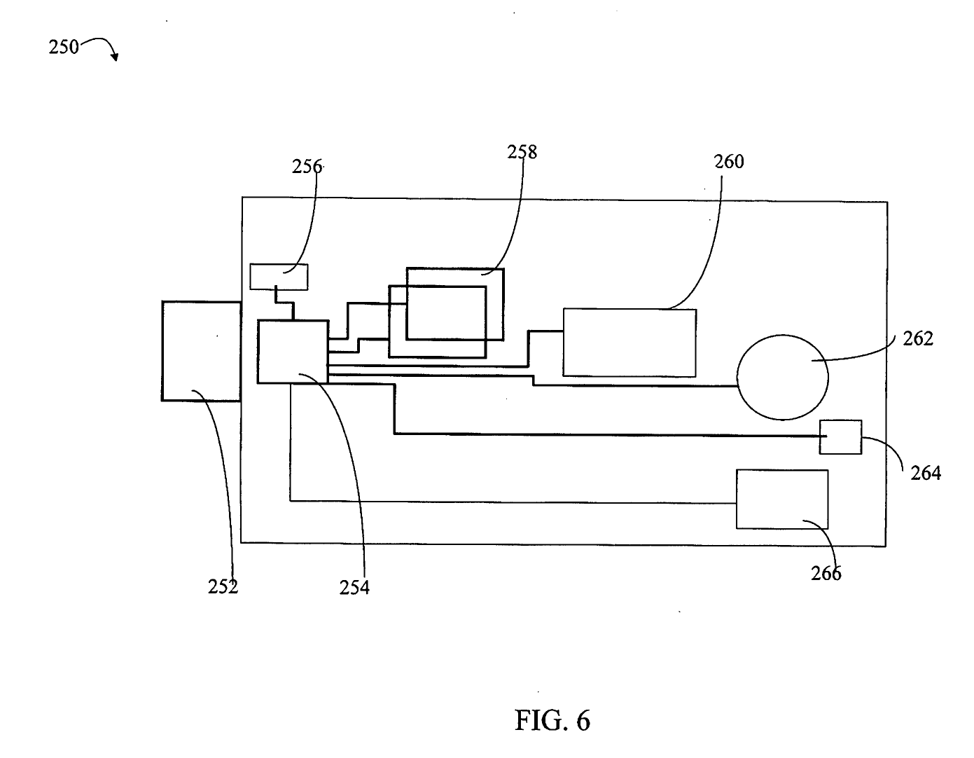

Referring now to FIG. 6, shown is an example of another embodiment of a capture device. The example 250 illustrates a block diagram of a capture device including functionality for image capture. As described in following paragraphs, the capture device 250 may be used in connection with capturing one or more images. The example 250 includes a USB connector 252, a device controller 254, a battery-backed clock 256, one or more flash memory components 258, a battery 260, a button 262, an image capture component 264, and a display 266.

Components 252, 254, 256, 258, and 260 are similar, respectively, to components 202, 204, 206, 208, and 210 illustrated in FIG. 5. The example 250 also includes an image capture component 264 and a display 266. The button 262 may operate as described elsewhere herein but in this example, the button 262 is used in connection with capturing image information. The image capture component 264 may include components used in a digital camera such as, for example, an optical system, image sensor, and the like, necessary to capture image information. The captured image information may be sent to the device controller 254 which also includes circuitry and components for processing the received image information, converting the received information to a digital form, and storing the resulting form of the image information in a location on the flash memory 258. The image information may be stored, for example, in a file in a particular location such as a default directory, folder, file, and the like. The image information may be in any one of a variety of different formats capable of representing a captured digital image. In the event that the captured image information includes multiple images, the captured information may be stored as a video file. The controller 254 may also determine and store additional information about the captured image information. The additional information may include metadata about the captured image information. The metadata may include date and/or time information as to when the image information is captured. The metadata may be stored with the captured image information, for example, as part of a same file, or otherwise associated with the corresponding captured image information. In one example, the capture device 300 may be used in connection with recording a series of images represented and stored in a video file format.

The display 266 may be used in connection with displaying the view of the image information to be captured.

In one embodiment, the image information captured between a single instance of starting and stopping an image recording may be included in a single file.

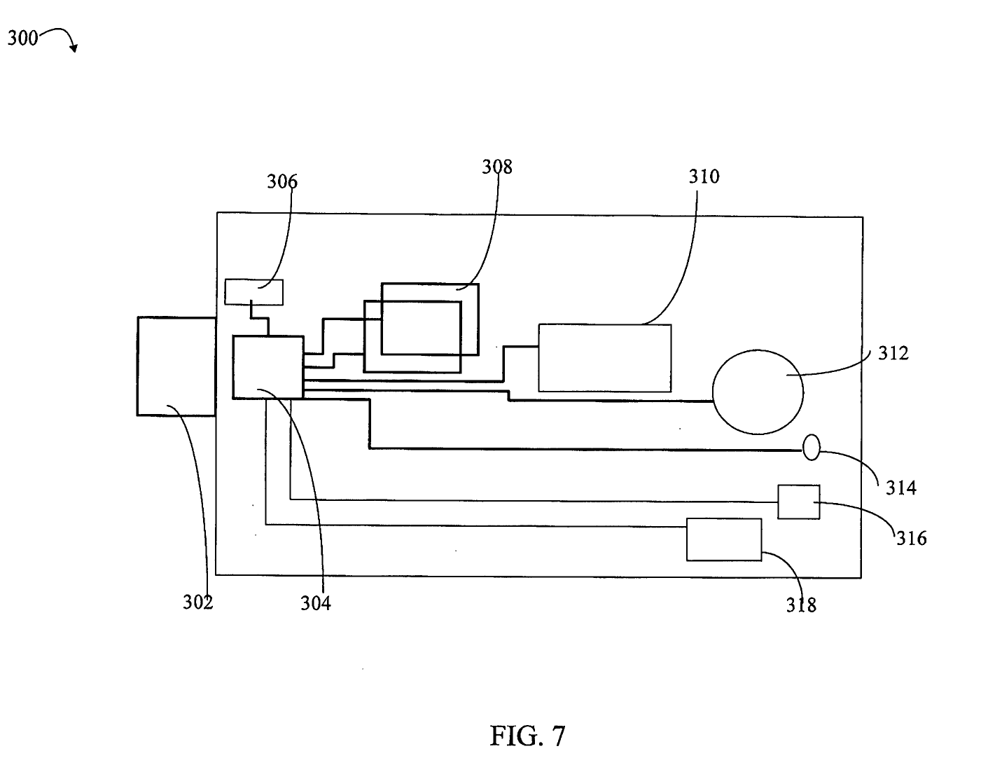

Referring now to FIG. 7, shown is an example of another embodiment of a capture device. The example 300 illustrates a block diagram of a capture device including functionality for audio and image capture. In this embodiment, the capture device 300 may be used in connection with capturing both audio and image information. The example 300 includes a USB connector 302, a device controller 304, a battery-backed clock 306, one or more flash memory components 308, a battery 310, a button 312, a microphone 314, an image capture component 316, and a display 318. Components of the example 300 are similar to components described elsewhere herein in connection with FIGS. 5 and 6. Additionally, in this example, the button 312 may be used to control operation of both the audio and image capture functionality. During operation, the button 312 may be used to simultaneously capture audio and image information. For example, one type of button described above may perform audio and image capture while the button is in a depressed state. Such audio and image capturing may continue until the button is released.

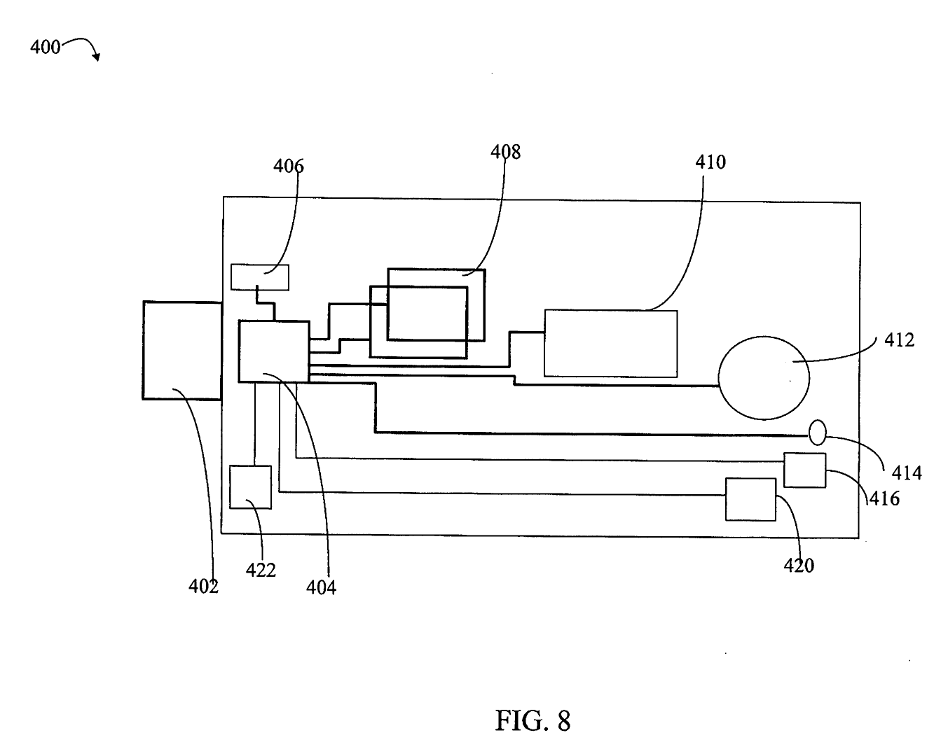

Referring now to FIG. 8, shown is an example of another embodiment of a capture device. The example 400 illustrates a block diagram of a capture device including functionality for audio and image capture. In this embodiment, the capture device 400 may be used in connection with capturing both audio and image information. The example 400 includes a USB connector 402, a device controller 404, a battery-backed clock 406, one or more flash memory components 408, a battery 410, a button 412, a microphone 414, an image capture component 416, and a display 420. Components of the example 400 are similar to components described elsewhere herein in connection with FIGS. 5, 6, and 7. Additionally, in this example, included is selector 422. In one embodiment, selector 422 may be used to select one or three states each indicating one of: enabling audio capture only, enabling image capture only, enabling simultaneous audio and image capture. Depending on the state of the selector 422, the components of 400 used in connection with audio and/image capture may be enabled and may operate in accordance with the button 412. If selector 422 is set to a first position, only audio capture is performed and component 414, but not components 416 and 420, operates in accordance with button 412. If selector 422 is set to a second position, only image capture is performed and components 416 and 420, but not component 414, may operate in accordance with button 412. If selector 422 is set to a third position, both image and audio capture may be performed and components 414, 416 and 420 are enabled and operate in accordance with button 412.

It should be noted that the functionality described herein in connection with the block diagrams for the capture device may include other components than as described herein. Additionally, it will be appreciated by those skilled in the art that the functionality described in the exemplary embodiments herein of a particular component performing processing may be performed by another component such as, for example, the audio and/or image processing of captured information.

As described elsewhere herein, the capture device may be used in connection with capturing audio and/or image information in a first standalone or offline mode. The capture device may be used, for example, in recording audio and/or image information throughout the day. At a later point, the user of the capture device may download the captured information to another device, such as a computer, for further processing. In connection with a second mode of use of the capture device, the capture device may be connected to another device, such as the computer 102 described elsewhere herein. In this latter case, the capture device may be used in connection with capturing information, such as an audio recording, while also being connected to the computer 102. In this case, the captured information may be downloaded to the computer 102 as soon as capture of the information is complete, or as the information is being captured.

The capture device may be configured to facilitate downloading of captured information to another device. In connection with the first standalone or offline mode, the capture device may be configured to facilitate automated download of previously captured information when the capture device is inserted into a port of another device, or in response to another action in connection with commencing communication with another device. In connection with the second mode when information is captured while the capture device is connected to another device, the captured information may be automatically downloaded to the other device. The captured information may be downloaded to a predetermined location on the other device, such as a file, folder, directory, and the like. The captured information may also be downloaded to another network location, such as to a server connected to the other device as illustrated in FIG. 1.

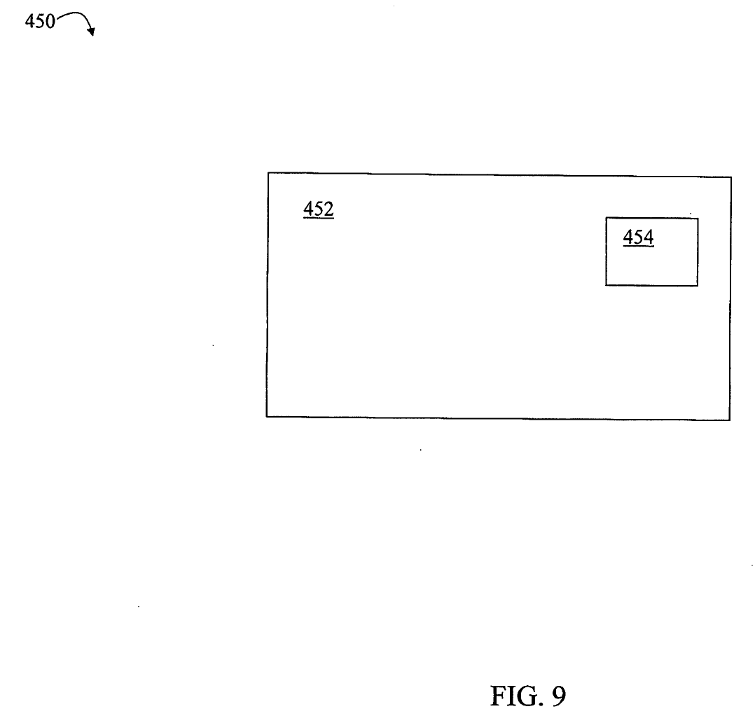

Referring now to FIG. 9, shown is an example illustrating an embodiment in which a capture device 454 is incorporated as an integrated component of another device 452. In the example 450, the capture device 454 may be any of the foregoing capture device embodiments, or other variations thereof. The other device 452 may be a computer or computer system component, such as a keyboard, and the capture device 454 may be integrated therein. For example, a computer keyboard of a desktop computer may include a capture device thereon. The button used to control the capturing of audio and/or image information may appear as a key or other button on the keyboard. In the foregoing example, the device 452 may be used in connection with further processing of the captured information and may operate in the second mode described herein where the captured information is automatically downloaded to the computer. In a variation of the foregoing, the captured information may be stored in a flash memory portion and not automatically downloaded to another location on the computer, such as folder on the system drive.

The capture device may also be integrated as a component in another device 452 in which the other device may be used only for capturing information.

The shape of the device into which the capture device is integrated may be in any one of a variety of different forms, shapes and sizes and made out of a variety different materials. For example, the capture device may be included in any object such as a pen cap, embedded in a pliable or flexible material or layers thereof, a button or pin, a credit-card sized device, a keyboard, a cell phone, a computer monitor or other peripheral, and the like.

The captured information may be downloaded from the capture device using a variety of different techniques that may vary with the type of other device including the capture device. For example, a credit card-sized device may include a capture device therein for capturing image and/or audio information. The image information may be displayed on one or more surfaces of the card and provide for a card that can be customized with captured images or videos. In one embodiment, the card may also include a magnetic or other encoded strip. When the card is “swiped”, such as when the card is placed in a card reader, the captured data may be transferred from the card to yet another device, such as a computer connected to the card reader.

As described elsewhere herein, the capture device may be inserted into a port of another device, such as a computer. Processing may be performed by the other device to facilitate downloading of the captured information to the other device. What will be described is an exemplary embodiment in which the other device is a computer and the capture device is a USB device inserted into a USB port of the computer. However, the techniques described herein may be performed with respect to other devices to which a capture device is connected as well as other types of capture devices. The techniques described may utilize an event driven model. In one embodiment, a technique may be used which utilizes functionality in the operating system of the computer to present an option to a user on a menu in response to insertion of the capture device. When the USB device is inserted into the port of the computer, the USB device may identify itself via its USB descriptor as a CDROM device to utilize automated functionality in the operating system. When the USB device that identifies itself as a CDROM device is brought online, the operating system performs processing to look for a particular file or application in a predetermined location on the USB device. If such a file or application exists in the predetermined location, the operating system automatically includes the file or application in a menu of options presented to the user. The user may then select from the menu the file or application which is then launched for execution. Thus, the foregoing technique may be used to invoke an application or file on the USB device itself.

In an embodiment, another technique may be used to invoke an application on the computer or other device to which the capture device is connected. An application on the computer may be registered to receive notification of certain events, such as notification of when the USB device is inserted into the computer. The notified application may then perform processing to facilitate downloading the data from the capture device. For example, based on the USB descriptor identifying the USB device as a CDROM, the operating system may launch an associated application. The associated application may be a web browser used to obtain credential information and log into a server on the network. Processing may then be performed to download the captured information from the capture device to the server connected to the computer.

The foregoing provides for techniques that may be used in connection with automating the download of captured information from a capture device. An embodiment may additionally, or alternatively, include functionality for downloading the captured information without having an action automatically performed when the capture device is connected to the computer. For example, the user may perform options for copying the captured data from the USB device to another user-specified location, or user specified application. Additionally, the foregoing techniques may be used in an embodiment in which the computer or other device is connected to a network, as described above, or when the computer or other device operates standalone without such connectivity, such as when performing processing locally on the device to which the captured information is downloaded.

The captured information may be used in connection with any of a variety of different purposes and applications. For example, the capture device may be used in connection with capturing information for a variety of user tasks when the user may be offline or not have connectivity to the particular application or another device, such as a computer, which utilizes the captured information. The capture device may be used to capture information ranging from, for example, user search queries, a grocery list, daily food intake or exercise, dictation of electronic documents, email, electronic calendar or appointment data, and the like. The captured information may include audio and/or image information. Subsequent to the downloading of the captured information, processing may be performed of the captured information to place the information in a form usable with a particular application. For example, captured audio information of a voice recording may be converted to text via a voice to text recognition module on a computer. The text may serve as input for use with any one of a variety of different applications such as, for example, a search query engine or other target. If the captured information is a single image and a text string is needed, for example, to form a search query, pattern recognition processing may be performed to generate a text string of any recognized text included in the image. In one embodiment, each set of captured information associated with a single file of captured information, such as each audio or image file, may be used in connection with performing a single action. For example, each audio clip may be used to form a new search query string if the captured information is to be used in connection with a search query.

The capture device may also be used as a mass storage device. As described herein, the captured information may be read from the capture device. Furthermore, data may be subsequently written to the capture device, for example, for subsequent use and retrieval by another device. The data written to the capture device may relate to the captured information. For example, after performing a search using a search query formed using data from the capture device, the search results may be stored on the capture device and associated with the corresponding search query. The capture device may also be used as a storage device to store any data thereon including data which may be characterized as not related to the captured information.

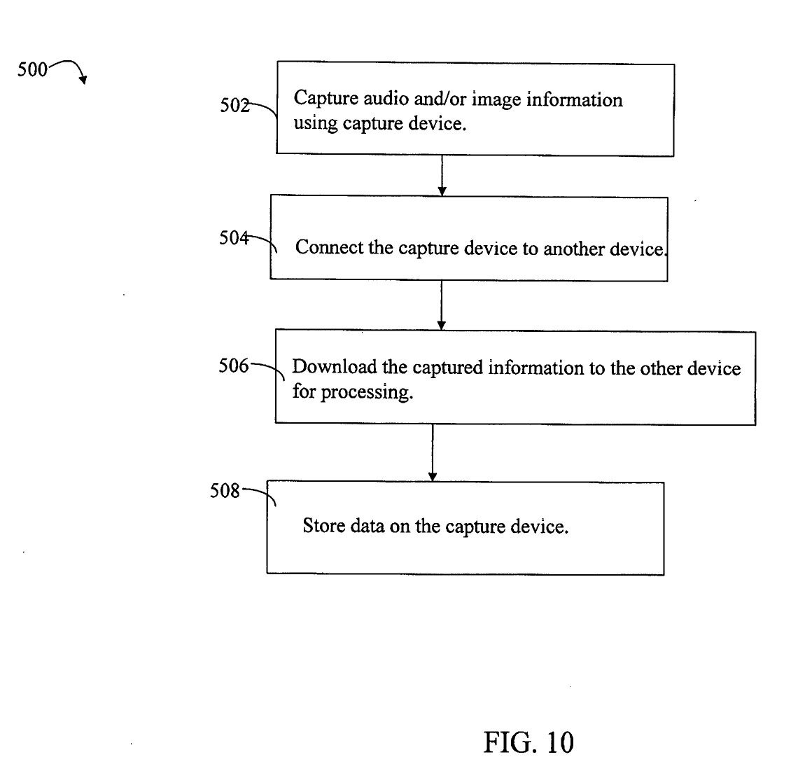

Referring now to FIG. 10, shown is a flowchart of processing steps that may be performed in connection with utilizing the capture device in connection with one embodiment. The processing steps of 500 may be performed in connection with an embodiment in which the capture device is a separate device which is then connected to another device. In other words, the steps of 500 describe processing that may be performed for information capturing when the capture device is not connected to another device or component to which the captured information is downloaded. At step 502, the audio and/or image information is captured using the capture device. In one embodiment as described herein, the capture device may be a USB device including flash memory. At step 504, the capture device may be connected to another device, such as a computer as described herein. At step 506, the captured information is downloaded to the other device for processing. As described herein, an embodiment may utilize any one of a variety of different ways to facilitate downloading of the captured data from the capture device. At step 508, data may also be optionally stored on the capture device. Step 508 may be performed in connection with applications in which the capture device is also used as a storage device. The data stored on the capture device is not limited to any particular kind of data in that the capture device may also be used as a mass storage device. In one embodiment, step 508 may include storing data on the capture device related to the captured information.

In another embodiment as described herein, the capture device may be integrated into the computer or other device. As such, with reference to flowchart 500, step 504 may be omitted in that the capture device may be connected to the other device due to the integration of the components. In this case, processing may include performing steps 502, 506, and optionally step 508.

As described herein, the capture device may be a USB device which is inserted into a USB port on a computer system or other device. The capture device may also be integrated as a component of another device. In one embodiment, the capture device may be characterized as a modified USB flash memory device including a capturing capabilities as described herein. The capture device may include audio and/or image recording capabilities. In one embodiment, the audio and/or image recording may be performed in a mode when the device is connected to a computer system or other component utilizing the captured information, as well as in another mode when the capture device is not connected to the foregoing computer system or other component. Audio capturing may be performed in response to selection of a button on the capture device which turns on and off the audio recording. For example, a button may be depressed causing a microphone on the device to record audio information. The microphone may continue to record until the button is released. Similarly, image or video capturing may be performed in response to selection of a button which turns on and off image recording. As such, the device may capture an image sequence as a video over a time period as well as a single image.

The capture device can record various types of captured content when the appropriate components of the capture device are enabled resulting in the creation of corresponding audio, image, and/or video files. The files may be stored in a non-volatile memory, such as a flash memory, of the capture device. The files may also include other metadata, such as date and time information, about the recording. When the capture device is plugged into a computer, such as one running a Windows-based operating system, any one of a variety of different techniques may be used to invoke an application or service included in the computer or other server having connectivity to the computer. The service of application may facilitate downloading the captured information from the capture device to a target location including, for example, the user computer directly connected to the capture device or another target location, such as the server computer, having connectivity thereto.

The capture device described herein has broad applicability for use in connection with capturing audio and/or image information, such as when offline with respect to a computer system. At a later point in time, the capture information may be downloaded to a computer or other component to which the capture device may be connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A capture device comprising:
at least one of an audio and a image capturing component for capturing information;
a flash memory; and
a button for use in connection with controlling capture of the information, capturing of the information being performed while holding the button in a depressed position and capturing of the information being stopped when the button is released.

2. The capture device of claim 1, wherein the capture device is a USB device and the capture device further comprising:
a USB connector that connects said capture device to another device.

3. The capture device of claim 1, further comprising a microphone for capturing audio information.

4. The capture device of claim 3, further comprising a component that gather time and date information about captured information.

5. The capture device of claim 1, wherein the information captured by the at least one of an audio and video capturing component is stored in the flash memory.

6. The capture device of claim 5, wherein the information is stored in a file in a predetermined location in the flash memory.

7. The capture device of claim 6, wherein the file includes metadata about captured information stored therein.

8. The capture device of claim 7,wherein the metadata includes at least one of date and time information.

9. The capture device of claim 1, wherein the information captured includes a plurality of images.

10. The capture device of claim 1, wherein the device includes components for performing audio and image capturing.

11. The capture device of claim 10, wherein the capturing of audio and image information is performed simultaneously using the button.

12. The capture device of claim 10, wherein the device includes a selector having three modes, a first mode indicating to perform only image capturing, a second mode indicating to perform only audio capturing, and a third mode indicating to perform both audio and image capturing.

13. The capture device of claim 1, wherein the device is included as a component integrated into another device.

14. A method for capturing information comprising:
providing a capture device for capturing at least one of an audio and image information;
using a button on the capture device to indicate when to start and stop capturing the information with capturing of the information being performed while holding the button in a depressed position and capturing of the information being stopped when the button is released; and
storing the information on a flash memory of the capture device.

15. The method of claim 14, further comprising:
selecting a mode of operation of the capture device indicating whether only image capturing, only audio capturing, or both audio and image capturing is performed.

16. The method of claim 14, further comprising:
inserting the capture device into another device;
launching an application to facilitate downloading the information from the capture device.

17. The method of claim 16, further comprising:
displaying, in response to said inserting, a menu of options, said menu including an option to launch said application; and
in response to selecting said option, performing said launching.

18. The method of claim 16, further comprising:
storing other data on the capture device by the other device.

19. A capture device comprising:
at least one component for performing audio capturing of audio information;
at least one component for performing image capturing of one or more images;
a non-volatile memory;
button controlling audio capturing and image capturing of information; and
a selector indicating a capture mode and enabling one or more components of the capture device in accordance with the capture mode.

20. The capture device of claim 19, wherein the non-volatile memory includes a predetermined location for storing captured audio information and another predetermined location for storing captured image information.
